(19) United States
(12) Patent Application Publication
(10) Pub. No.: US 2026/0118212 A1
(43) Pub. Date: Apr. 30, 2026

(54) MEASUREMENT DEVICE AND MEASUREMENT METHOD FOR MEASURING VIBRATION CHARACTERISTICS OF WORKPIECE

(71) Applicant: NHK SPRING CO., LTD., Yokohama-shi (JP)

(72) Inventors: Tatsuhiko NISHIDA, Yokohama-shi (JP); Gaku NASHIMOTO, Yokohama-shi (JP)

(73) Assignee: NHK SPRING CO., LTD., Yokohama-shi (JP)

(21) Appl. No.: 19/365,855

(22) Filed: Oct. 22, 2025

(30) Foreign Application Priority Data
Oct. 30, 2024 (JP) 2024-190709

(51) Int. Cl. G01M 7/02; G11B 5/48

(52) U.S. Cl. CPC G01M 7/025; G11B 5/4833

(57) ABSTRACT

A hard disk drive suspension includes first piezoelectric elements provided at a first position, and second piezoelectric elements provided at a second position. A conductor is connected to the first piezoelectric elements. Conductors are connected to the second piezoelectric elements, respectively. A measurement device includes a vibration signal generation unit which supplies vibration signals to the second piezoelectric elements, a vibration measurement unit which detects vibration generated at the suspension, and a ground connection unit. The conductor electrically connected to the first piezoelectric elements is connected to a ground via a resistor of a ground connection unit.

### CROSS-REFERENCE TO RELATED APPLICATIONS

This application is based upon and claims the benefit of priority from prior Japanese Patent Application No. 2024-190709, filed Oct. 30, 2024, the entire contents of which are incorporated herein by reference.

### BACKGROUND OF THE INVENTION

### 1. Field of the Invention

The present invention relates to a measurement device and a measurement method for measuring vibration characteristics of a workpiece comprising an actuator such as a piezoelectric element.

### 2. Description of the Related Art

A hard disk drive (HDD) is used in an information processing apparatus such as a personal computer. The hard disk drive is hereinafter referred to as a disk drive. The disk drive includes a magnetic disk which rotates about a spindle, a carriage which turns about a pivot, and the like. A disk drive suspension is provided on an arm of the carriage. The disk drive suspension is an example of a work described herein. The disk drive suspension is hereinafter simply referred to as a suspension.

The suspension comprises a base plate, a load beam, a flexure provided along the load beam, and the like. A slider is provided on a gimbal portion formed near a distal end of the flexure. An element for performing access such as reading or writing of data recorded in a disk is provided on a slider.

To increase the recording density of the disk, the magnetic head needs to be positioned more quickly and more accurately relative to the recording surface of the disk. For this reason, a suspension equipped with an actuator for coarse movement and an actuator for fine movement has been developed. A piezoelectric element which operates in response to a voltage is known as an actuator for fine movement.

A suspension disclosed in JP2013-246840A (Patent Literature 1) has an actuator mounted near a base plate of the suspension. A suspension disclosed in JP2014-22015A (Patent Literature 2) has an actuator for fine movement mounted on a gimbal portion. A multi-stage actuator-type suspension comprising an actuator for coarse movement and an actuator for fine movement is also known.

To ensure that the suspension functions properly, it is necessary to accurately understand vibration characteristics of the suspension. For this reason, devices for measuring the vibration characteristics of suspensions have been developed. For example, a measurement device comprising a laser Doppler vibration meter is disclosed in JP2007-192735A (Patent Literature 3). The measurement device disclosed in Patent Literature 3 includes a vibration generator that vibrates the suspension, a detector that emits laser light onto the suspension and detects the reflected light, and the like.

In tests to measure the vibration characteristics, the suspension itself is also vibrated using the actuator mounted on the suspension. For example, in a suspension equipped with actuators at first and second positions, the suspension is vibrated by supplying a vibration signal to the actuator at the first position. As described herein, the actuator to which vibration signals are supplied during a vibration test is referred to as a vibration-side actuator, and the actuator to which no vibration signals are supplied is referred to as a non-vibration-side actuator.

Depending on the specifications of the disk drive, a first suspension facing a first face of a disk and a second suspension facing a second face of the disk may be provided. The first suspension is provided such that an air bearing surface of a slider faces the first face (for example, a surface) of the disk. The second suspension is provided such that the air bearing surface of the slider faces the second face (for example, a back surface) of the disk. The first suspension and the second suspension have shapes mirroring with the disk sandwiched therebetween.

Therefore, in vibration tests, if the vibration signals supplied to the first suspension and the second suspension are the same, the vibration waveforms of the first suspension and the second suspension should be the same. In intensive research, however, the present inventors found cases where the vibration waveforms of the first suspension and the second suspension are inconsistent.

The present inventors conducted intensive research on the reason why the vibration waveforms of the first suspension and the second suspension are different from each other. As a result, the present inventors obtained knowledge that the reason was likely to be crosstalk occurring in wires connected to the actuator. If the actuator vibrating the suspensions was affected by crosstalk, the measured vibration characteristics might become inaccurate.

The object of the present invention is to provide a measurement device and a measurement method capable of accurately measuring vibration characteristics of a workpiece in a test for measuring vibration characteristics of a workpiece including an actuator.

### BRIEF SUMMARY OF THE INVENTION

A workpiece whose vibration is measured by the measuring device of one embodiment includes a first actuator provided at a first position, a conductor electrically connected to the first actuator, a second actuator provided at a second position, and a conductor connected to the second actuator. The measurement device for measuring the vibration characteristics of the workpiece comprises a vibration signal generation unit, a vibration measurement unit, and a ground connection unit connected to a ground. The vibration signal generation unit supplies a vibration signal to either the first actuator or the second actuator. The vibration measurement unit detects vibrations generated in the workpiece by the actuator to which the vibration signal is supplied. The ground connection unit connects the non-vibration-side actuator to which the vibration signal is not supplied, among the first actuator and the second actuator, to the ground.

In the measurement device of one embodiment, the ground connection unit may have a resistor, and the non-vibration-side actuator may be connected to the ground via the resistor. In addition, the first actuator may include a first piezoelectric element. The second actuator may include a second piezoelectric element. The impedance of the resistor may desirably be lower than the impedance of the piezoelectric element to which the vibration signal is supplied. When a stroke of the first piezoelectric element is larger than a stroke of the second piezoelectric element, the first piezoelectric element is connected to the ground connection unit, and the vibration signal is supplied to the second piezoelectric element.

A measurement method of one embodiment is a measurement method for measuring the vibration characteristics of the workpiece. The non-vibration-side actuator to which the vibration signal is not supplied, among the first actuator and the second actuator, is connected to the ground. The vibration signal is supplied to the vibration-side actuator among the first actuator and the second actuator, and the vibration generated in the workpiece by the vibration-side actuator is detected.

In the measurement method of one embodiment, the vibration signal may be supplied to the vibration-side actuator in a state in which a resistor is provided between the non-vibration-side actuator and the ground. The impedance of the resistor is desirably lower than the impedance of the vibration-side actuator.

According to the measurement device and the measurement method of one embodiment of the present invention, the influence of crosstalk is suppressed, and the vibration characteristics of a workpiece can be measured more accurately, in a test for measuring the vibration characteristics of a workpiece including an actuator.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing an example of a disk drive.

FIG. 2 is a cross-sectional view schematically showing the disk drive.

FIG. 3 is a plan view showing an example of a first suspension.

FIG. 4 is a plan view showing an example of a second suspension.

FIG. 5 is a plan view schematically showing a measuring device according to the first embodiment and the first suspension.

FIG. 6 is a plan view schematically showing the measuring device according to the first embodiment and the second suspension.

FIG. 7 is a block diagram showing an example of an electrical circuit of the measuring device.

FIG. 8 is a graph showing a vibration waveform of the first suspension shown in FIG. 5 and a vibration waveform of the second suspension shown in FIG. 6.

FIG. 9 is a graph showing a relationship between a vibration signal of the first suspension shown in FIG. 5 and a crosstalk voltage.

FIG. 10 is a graph showing a relationship between a vibration signal of the second suspension shown in FIG. 6 and a crosstalk voltage.

FIG. 11 is a graph showing vibration waveforms of a first suspension and a second suspension according to a second embodiment.

FIG. 12 is a graph showing a relationship between the vibration signal of the first suspension according to the second embodiment and a crosstalk voltage.

FIG. 13 is a graph showing a relationship between the vibration signal of the second suspension according to the second embodiment and a crosstalk voltage.

FIG. 14 is a plan view schematically showing a part of a measuring device according to a third embodiment and a first suspension.

FIG. 15 is a plan view schematically showing a first suspension of Comparative Example 1.

FIG. 16 is a graph showing vibration waveforms of the first suspension and a second suspension of Comparative Example 1.

FIG. 17 is a plan view schematically showing a first suspension of Comparative Example 2.

FIG. 18 is a graph showing vibration waveforms of the first suspension and a second suspension of Comparative Example 2.

FIG. 19 is a plan view schematically showing a part of a measuring device according to a fourth embodiment and a first suspension.

FIG. 20 is a plan view schematically showing a part of a measuring device according to a fourth embodiment and a second suspension.

### DETAILED DESCRIPTION OF THE INVENTION

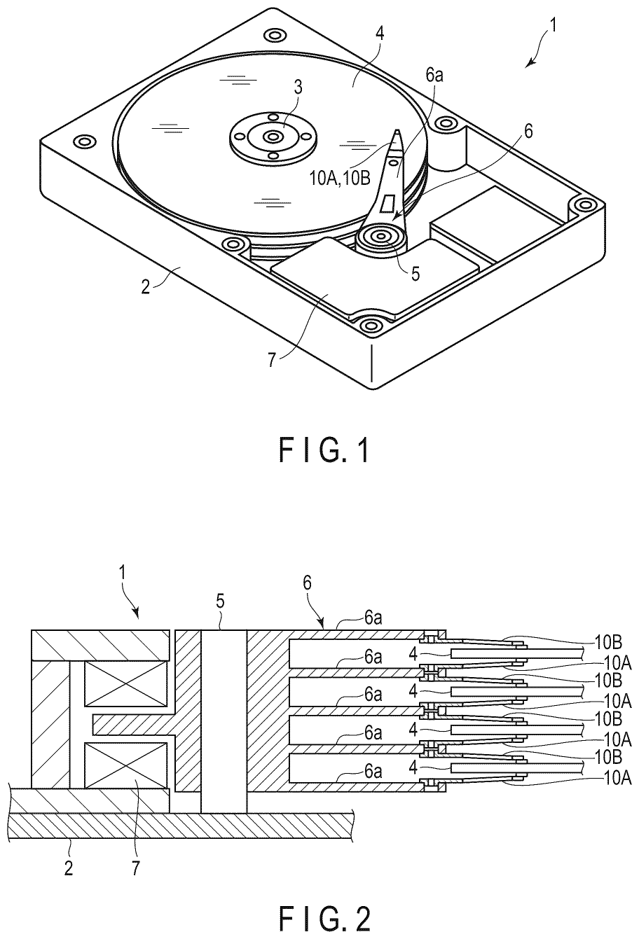

First, a first suspension 10A and a second suspension 10B will be described with reference to FIGS. 1 to 4. The first suspension 10A and the second suspension 10B are examples of objects (workpieces) for measuring vibrations. However, the present invention can also be applied when measuring vibration characteristics of one of the first suspension 10A and the second suspension 10B.

FIG. 1 is a perspective view showing an example of a hard disk drive (HDD) 1. The hard disk drive is hereinafter simply referred to as a disk drive. FIG. 2 is a cross-sectional view schematically showing the disk drive 1. The disk drive 1 includes a casing 2, a disk 4 which rotates around a spindle 3, a carriage 6, a positioning motor 7, and the like. The carriage 6 revolves about a pivot 5. The motor 7 functions as an actuator to make the carriage 6 revolve. The casing 2 is sealed by a lid (not shown).

As shown in FIG. 2, the first suspension 10A is attached to a first surface of each arm 6a of the carriage 6. The second suspension 10B is mounted on a second surface (i.e., a surface on a side opposite to the first surface) of each arm 6a. The first suspension 10A and the second suspension 10B face each other with the disk 4 interposed therebetween.

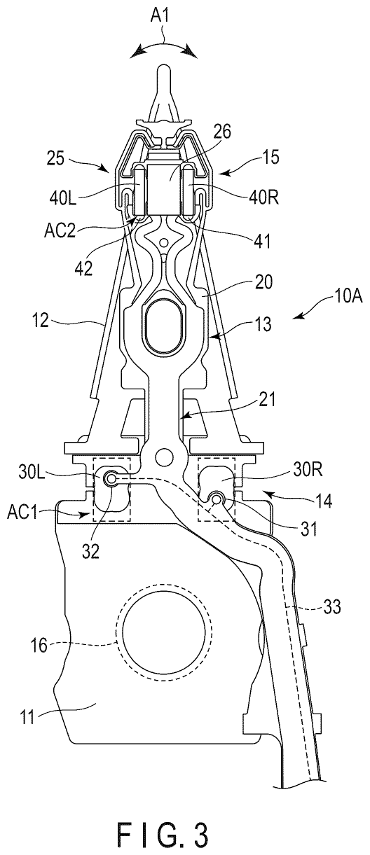

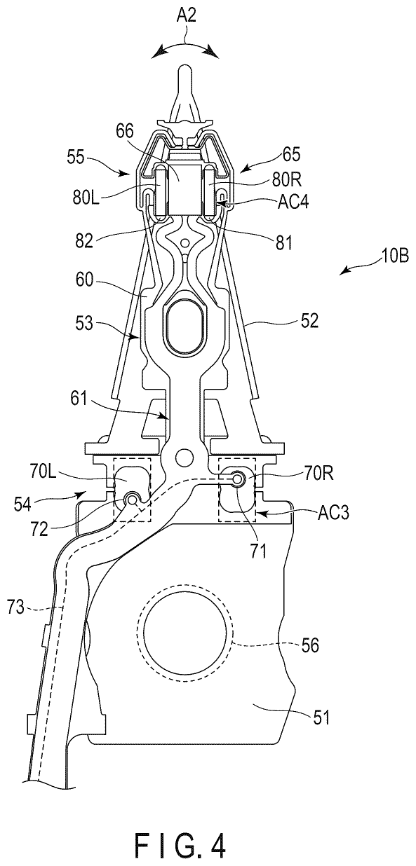

FIG. 3 is a plan view showing an example of the first suspension 10A. FIG. 4 is a plan view showing an example of the second suspension 10B. The first suspension 10A and the second suspension 10B are configured to be mirroring with the disk 4 interposed therebetween. For this reason, the configurations of the first suspension 10A and the second suspension 10B are substantially equivalent to each other.

The first suspension 10A shown in FIG. 3 includes a base plate 11, a load beam 12, a flexure 13, an actuator mounting portion 14 provided at a first position, and an actuator mounting portion 15 provided at a second position. In this example, the first position refers to a position close to the base plate 11 in a length direction of the suspension 10A. The second position is located near a distal end of the suspension 10A. The base plate 11 and the load beam 12 are formed of, for example, stainless steel plates. A circular boss portion 16 is formed in the base plate 11. The boss portion 16 is fixed to an arm 6a of the carriage 6 (shown in FIG. 2).

The flexure 13 includes a metal base 20 and a wiring portion 21. The metal base 20 is formed of a stainless steel plate which is thinner than the load beam 12. The wiring portion 21 is provided along the metal base 20. A swingable gimbal portion 25 is formed near the distal end of the flexure 13. A slider 26 which functions as a magnetic head is mounted on the gimbal portion 25. An element for magnetically recording data on the disk 4, an element for reading data recorded on the disk 4, and the like are provided on the slider 26.

A pair of piezoelectric elements 30R and 30L, which serve as a first actuator AC1, are provided on the actuator mounting portion 14 at the first position. As described herein, these piezoelectric elements 30R and 30L are referred to as first piezoelectric elements. Each of the first piezoelectric elements 30R and 30L is composed of lead zirconate titanate (PZT) or the like.

In FIG. 3, a conductor 33 is connected to one of electrodes of the piezoelectric element 30R located on the right side, via the terminal 31 of the wiring portion 21. The other electrode of the piezoelectric element 30R is electrically connected to the metal portion (for example, the base plate 11) which constitutes a ground side electric circuit of the first suspension 10A.

In FIG. 3, a conductor 33 is connected to one of electrodes of the piezoelectric element 30L located on the left side, via the terminal 32 of the wiring portion 21. The other electrode of the piezoelectric element 30L is electrically connected to the metal portion which constitutes a ground side electric circuit of the first suspension 10A.

The piezoelectric elements 30R and 30L have the same configuration, but are provided in the actuator mounting portion 14 with their (positive and negative) polarities reversed. For this reason, when a common voltage is applied to the terminals 31 and 32, the piezoelectric elements 30R and 30L extend or contract in opposite directions. Thus, the distal end of the first suspension 10A can be moved by a small amount in the sway direction (indicated by double-headed arrow A1 in FIG. 3). For example, when the piezoelectric element 30R contracts and the piezoelectric element 30L extends, the distal end of the first suspension 10A moves in the first direction. When the piezoelectric element 30R extends and the piezoelectric element 30L contracts, the distal end of the first suspension 10A moves in the second direction.

A pair of piezoelectric elements 40R and 40L serving as the second actuator AC2 are arranged on the actuator mounting portion 15 at the second position. As described herein, these piezoelectric elements 40R and 40L are referred to as second piezoelectric elements. Each of the second piezoelectric elements 40R and 40L is composed of lead zirconate titanate (PZT) or the like. In FIG. 3, an R-side conductor 41 of the wiring portion 21 is connected to one of electrodes of the piezoelectric element 40R located on the right side. The other electrode of the piezoelectric element 40R is electrically connected to the ground side electric circuit of the first suspension 10A.

In FIG. 3, an L-side conductor 42 of the wiring portion 21 is connected to one of electrodes of the piezoelectric element 40L located on the left side. The other electrode of the piezoelectric element 40L is electrically connected to the ground side electric circuit of the first suspension 10A.

When a voltage is applied to the piezoelectric element 40R through the R-side conductor 41 and a voltage is applied to the piezoelectric element 40L through the L-side conductor 42, the piezoelectric elements 40R and 40L extend or contract in response to the voltages. Thus, the distal end of the first suspension 10A can be moved by a small amount in the sway direction (indicated by double-headed arrow A1 in FIG. 3).

For example, when the piezoelectric element 40R contracts and the piezoelectric element 40L extends, the distal end of the first suspension 10A moves in the first direction. When the piezoelectric element 40R extends and the piezoelectric element 40L contracts, the distal end of the first suspension 10A moves in the second direction. The stroke of the piezoelectric elements 40R and 40L at the second position is smaller than the stroke of the piezoelectric elements 30R and 30L at the first position.

FIG. 4 shows the second suspension 10B. The second suspension 10B has a mirroring shape of the first suspension 10A. For this reason, the second suspension 10B will be described briefly.

The second suspension 10B shown in FIG. 4 includes a base plate 51, a load beam 52, a flexure 53, an actuator mounting portion 54 provided at a first position, and an actuator mounting portion 55 provided at a second position. In this example, the first position refers to a position close to the base plate 51 in a length direction of the second suspension 10B. The second position is located near a distal end of the second suspension 10B. A circular boss portion 56 is formed in the base plate 51. The boss portion 56 is fixed to an arm 6a of the carriage 6 (shown in FIG. 2).

The flexure 53 includes a metal base 60 and a wiring portion 61. A swingable gimbal portion 65 is formed near the distal end of the flexure 53. A slider 66 is mounted on the gimbal portion 65.

A pair of piezoelectric elements 70R and 70L, which serve as a first actuator AC3, are provided on the actuator mounting portion 54 at the first position. As described herein, these piezoelectric elements 70R and 70L are referred to as first piezoelectric elements. In FIG. 4, a conductor 73 is connected to one of electrodes of the first piezoelectric element 70R located on the right side, via the terminal 71 of the wiring portion 61. The other electrode of the piezoelectric element 70R is electrically connected to the metal portion which constitutes a ground side electric circuit of the second suspension 10B.

In FIG. 4, a conductor 73 is connected to one of electrodes of the first piezoelectric element 70L located on the left side, via the terminal 72 of the wiring portion 61. The other electrode of the piezoelectric element 70L is electrically connected to the metal portion which constitutes a ground side electric circuit of the second suspension 10B.

The piezoelectric elements 70R and 70L have the same configuration, but are provided in the actuator mounting portion 54 with their polarities reversed. For this reason, when a common voltage is applied to the terminals 71 and 72, the piezoelectric elements 70R and 70L extend or contract in opposite directions. Thus, the distal end of the second suspension 10B can be moved by a small amount in the sway direction (indicated by double-headed arrow A2 in FIG. 4).

A pair of piezoelectric elements 80R and 80L serving as the second actuator AC4 are arranged on the actuator mounting portion 55 at the second position. As described herein, these piezoelectric elements 80R and 30L are referred to as second piezoelectric elements. In FIG. 4, an R-side conductor 81 of the wiring portion 61 is connected to one of electrodes of the second piezoelectric element 80R located on the right side. The other electrode of the piezoelectric element 80R is electrically connected to the ground side electric circuit of the second suspension 10B.

In FIG. 4, an L-side conductor 82 of the wiring portion 61 is connected to one of electrodes of the second piezoelectric element 80L located on the left side. The other electrode of the piezoelectric element 80L is electrically connected to the ground side electric circuit of the second suspension 10B.

When a voltage is applied to the piezoelectric element 80R through the R-side conductor 81 and a voltage is applied to the piezoelectric element 80L through the L-side conductor 82, the piezoelectric elements 80R and 80L extend or contract in response to the voltages. Thus, the distal end of the second suspension 10B can be moved by a small amount in the sway direction (indicated by double-headed arrow A2 in FIG. 4). The stroke of the piezoelectric elements 80R and 80L at the second position is smaller than the stroke of the piezoelectric elements 70R and 70L at the first position.

### First Embodiment

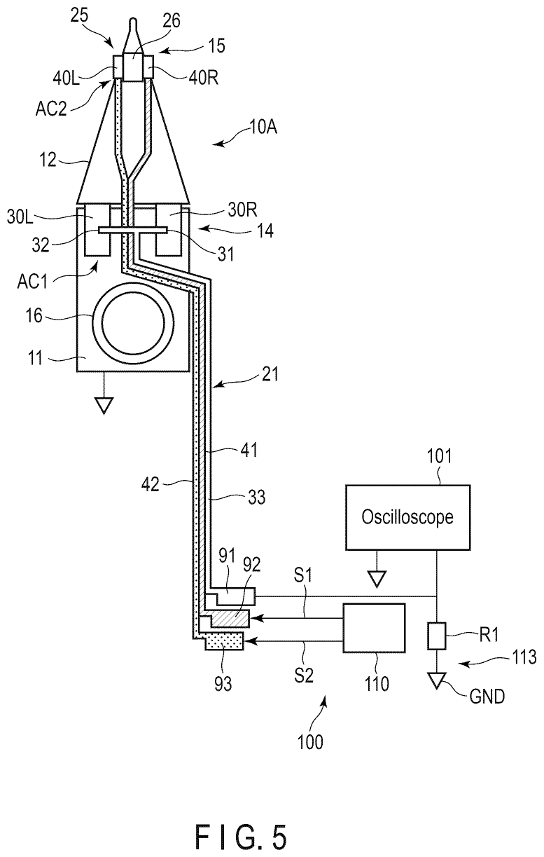

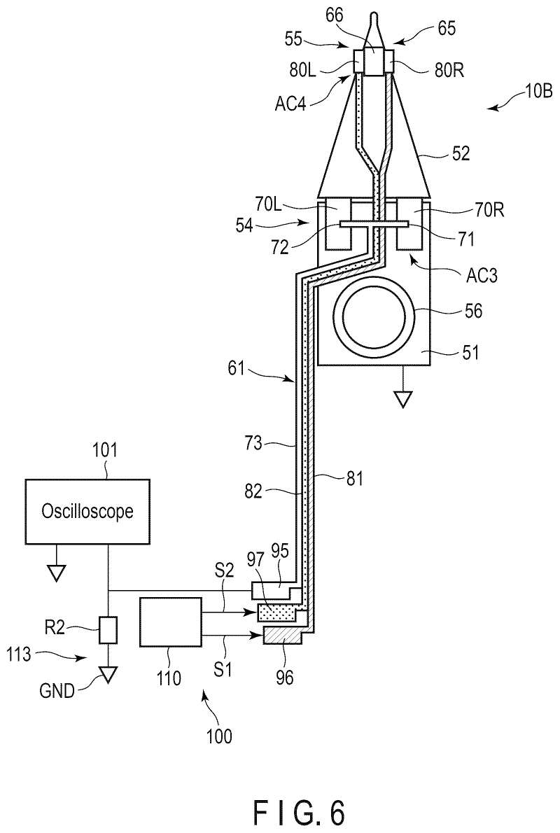

A measurement device 100 and measurement method for measuring vibration characteristics will be described below with reference to FIG. 5 to FIG. 10. FIG. 5 schematically shows a part of the measurement device 100 and the first suspension 10A. FIG. 6 schematically shows a part of the measurement device 100 and the second suspension 10B.

As shown in FIG. 5, terminal portions 91, 92, and 93 are provided on the wiring portion 21 of the first suspension 10A. The terminal portion 91 is electrically connected to the piezoelectric elements 30R and 30L at the first position via the conductor 33. The terminal portion 92 is electrically connected to the piezoelectric element 40R at the second position via the R-side conductor 41. The R-side conductor 41 is adjacent to the conductor 33 and provided along the conductor 33. For convenience of descriptions, the R-side conductor 41 and the terminal portion 92 are represented by hatching in FIG. 5.

The terminal portion 93 shown in FIG. 5 is electrically connected to the piezoelectric element 40L at the second position via the L-side conductor 42. The L-side conductor 42 is provided along the R-side conductor 41. In FIG. 5, the L-side conductor 42 and the terminal portion 93 are represented with a sand pattern. As described herein, the piezoelectric elements 30R and 30L at the first position may be referred to as the first piezoelectric elements, and the piezoelectric elements 40R and 40L at the second position may be referred to as the second piezoelectric elements.

As shown in FIG. 6, terminal portions 95, 96, and 97 are provided on the wiring portion 61 of the second suspension 10B. The terminal portion 95 is electrically connected to the piezoelectric elements 70R and 70L at the first position via the conductor 73. The terminal portion 96 is electrically connected to the piezoelectric element 80R at the second position via the R-side conductor 81. For convenience of descriptions, the R-side conductor 81 and the terminal portion 96 are represented by hatching in FIG. 6.

The terminal portion 97 shown in FIG. 6 is electrically connected to the piezoelectric element 80L at the second position via the L-side conductor 82. The L-side conductor 82 is adjacent to the conductor 73 and provided along the conductor 73. In contrast, the R-side conductor 81 is provided along the L-side conductor 82. In FIG. 6, the L-side conductor 82 and the terminal portion 97 are represented with a sand pattern. As described herein, the piezoelectric elements 70R and 70L at the first position may be referred to as the first piezoelectric elements, and the piezoelectric elements 80R and 80L at the second position may be referred to as the second piezoelectric elements.

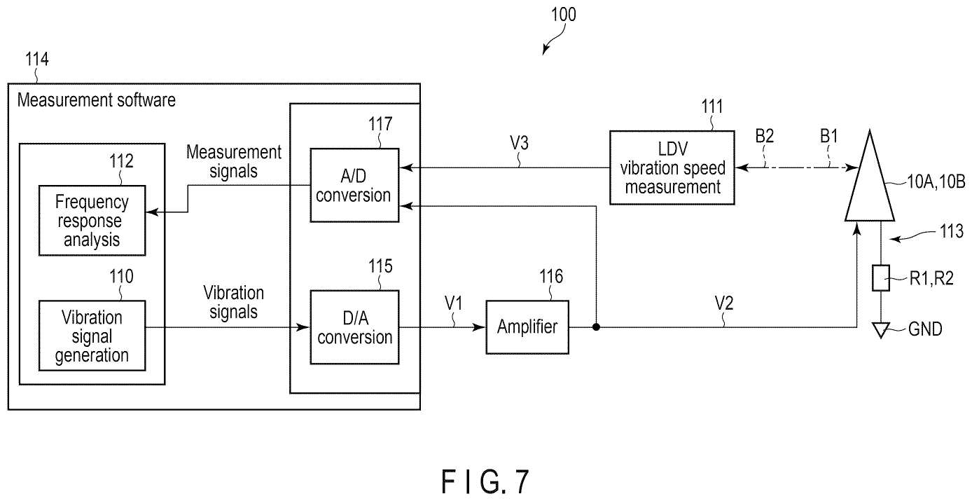

FIG. 7 is a block diagram showing an example of the measurement device 100. The measurement device 100 includes a vibration signal generation unit 110, a vibration measurement unit 111, a frequency response analysis unit 112, a ground connection unit 113, and the like. The vibration signal generation unit 110 and the frequency response analysis unit 112 may be part of an information processing unit 114 such as a computer equipped with measurement software or the like.

The vibration signal generated by the vibration signal generation unit 110 is converted into a vibration signal voltage V1 via a digital/analog converter 115. The vibration signal voltage V1 is amplified by an amplifier 116, and a drive voltage V2 to drive the piezoelectric elements is generated. The drive voltage V2 is supplied to the piezoelectric element on the vibration side of the first suspension 10A or the piezoelectric element on the vibration side of the second suspension 10B.

As shown in FIG. 5, when performing a vibration test on the first suspension 10A, the terminal portion 91 electrically connected to the piezoelectric elements 30R and 30L at the first position is connected to ground (signal ground) GND via a resistor R1. In this state, vibration signals S1 and S2 are supplied to terminal portions 92 and 93, which are electrically connected to the piezoelectric elements 40R and 40L at the second position, respectively.

The stroke of extension and contraction of the piezoelectric elements 30R and 30L provided at the first position is greater than the stroke of extension and contraction of the piezoelectric elements 40R and 40L provided at the second position. In this case, the ground connection unit 113 is desirably connected to the piezoelectric elements 30R and 30L provided at the first position. Then, the vibration signals S1 and S2 are supplied to the piezoelectric elements 40R and 40L at the second position.

The vibration signals S1 and S2 are generated by the vibration signal generation unit 110 and cause the piezoelectric elements 40R and 40L at the second position to vibrate. An oscilloscope 101 may be used to measure waveforms of the vibration signals and waveforms of the crosstalk. As described herein, the piezoelectric element to which vibration signals are supplied is referred to as a vibration-side piezoelectric element, and the piezoelectric element to which vibration signals are not supplied is referred to as a non-vibration-side piezoelectric element.

When the vibration signals are supplied to the piezoelectric elements 40R and 40L at the second position and the first suspension 10A vibrates, the vibration velocity of the first suspension 10A is detected by the vibration measurement unit 111 (shown in FIG. 7). An example of the vibration measurement unit 111 is a laser Doppler velocimeter. The vibration measurement unit 111 detects the vibration velocity, and the like, based on the laser irradiation light B1 and the laser reflected light B2.

The output of the vibration measurement unit 111 (voltage V3 related to the vibration velocity) is converted into a measurement signal via an analog/digital converter 117 and input to the frequency response analysis unit 112. The frequency response analysis unit 112 obtains the vibration characteristics of the first suspension 10A, based on measurement software such as a frequency response function.

As shown in FIG. 6, when performing a vibration test on the second suspension 10B, the terminal portion 95 electrically connected to the piezoelectric elements 70R and 70L at the first position is connected to ground (signal ground) GND via a resistor R2. In this state, vibration signals S1 and S2 are supplied to terminal portions 96 and 97, which are electrically connected to the piezoelectric elements 80R and 80L at the second position, respectively.

The stroke of the piezoelectric elements 70R and 70L provided at the first position is greater than the stroke of the piezoelectric elements 80R and 80L provided at the second position. In this case, the ground connection unit 113 is desirably connected to the piezoelectric elements 70R and 70L provided at the first position. Then, the vibration signals S1 and S2 are supplied to the piezoelectric elements 80R and 80L provided at the second position. The vibration characteristics of the second suspension 10B can be measured by the measurement device 100 in the same manner as those of the first suspension 10A.

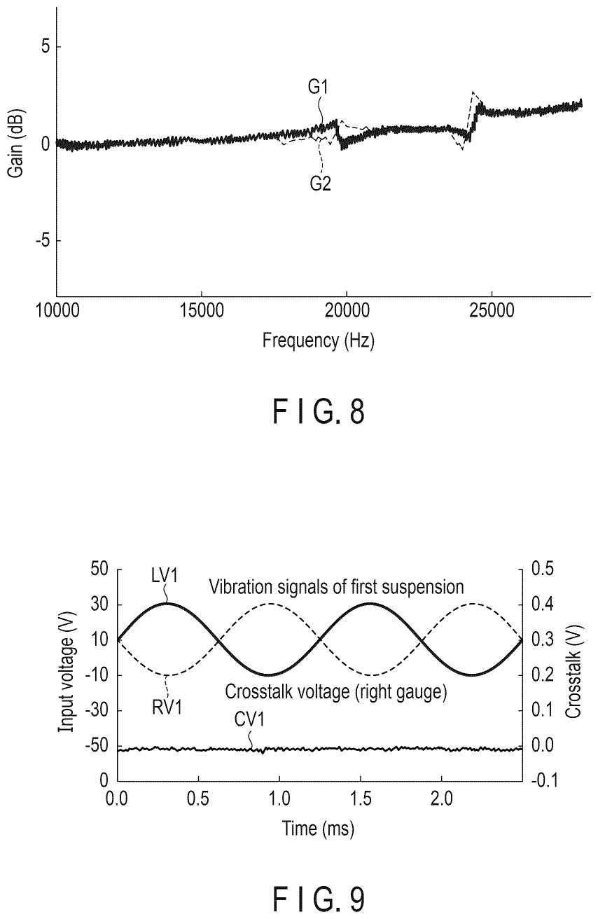

FIG. 8 shows a vibration waveform G1 of the first suspension 10A and a vibration waveform G2 of the second suspension 10B, which are measured by the measurement device 100. In FIG. 8, a horizontal axis indicates a frequency, and a vertical axis indicates a gain.

In FIG. 8, G1 indicates a vibration waveform of the first suspension 10A when the piezoelectric elements 40R and 40L of the first suspension 10A are vibrated. The vibration signal is supplied to the piezoelectric elements 40R and 40L via the R-side conductor 41 and the L-side conductor 42. In contrast, the vibration signals are not supplied to the piezoelectric elements 30R and 30L at the first position. These piezoelectric elements 30R and 30L are connected to a ground GND via a low-impedance resistor R1 (for example, 50Ω).

In FIG. 8, G2 indicates a vibration waveform of the second suspension 10B when the piezoelectric elements 80R and 80L of the second suspension 10B are vibrated. The vibration signal is supplied to the piezoelectric elements 80R and 80L via the R-side conductor 81 and the L-side conductor 82. In contrast, the vibration signals are not supplied to the piezoelectric elements 70R and 70L at the first position. These piezoelectric elements 70R and 70L are connected to a ground GND via a low-impedance resistor R2 (for example, 50Ω).

Since the first suspension 10A and the second suspension 10B have mirroring shapes, vibration waveforms can be the same if the vibration signals S1 and S2 common to both the suspensions are supplied. In fact, however, slight differences are observed in the vibration waveforms G1 and G2 at frequencies around 20,000 Hz and 25,000 Hz as shown in FIG. 8. The present inventors finding the differences focused on the crosstalk generated in the first suspension 10A and the crosstalk generated in the second suspension 10B.

FIG. 9 shows vibration signals (input voltages RV1 and LV1) of the first suspension 10A and crosstalk voltage CV1, which are observed by the oscilloscope 101. A small crosstalk voltage CV1 is observed in response to the input voltages RV1 and LV1.

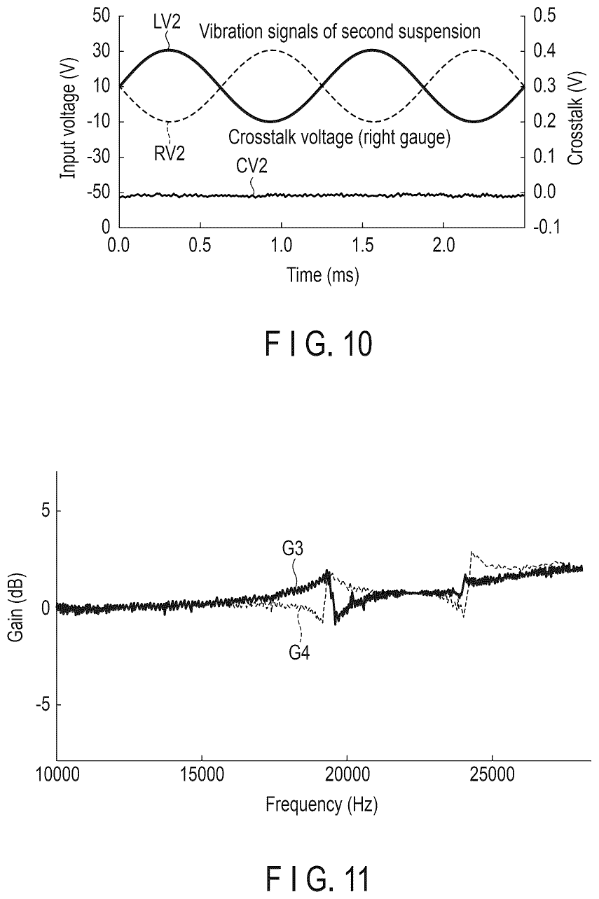

FIG. 10 shows vibration signals (input voltages RV2 and LV2) of the second suspension 10B and crosstalk voltage CV2, which are observed by the oscilloscope 101. A small crosstalk voltage CV2 is observed in response to the input voltages RV2 and LV2. It is considered that the deviation between the crosstalk voltages CV1 and CV2 causes the deviation between the vibration waveforms G1 and G2 (shown in FIG. 8).

### Second Embodiment

In a second embodiment, a high-impedance resistor R1 (1 MΩ) is connected to the terminal portion 91 of the first suspension 10A (shown in FIG. 5). In addition, a high-impedance resistor R2 (1 MΩ) is connected to the terminal portion 95 of the second suspension 10B (shown in FIG. 6).

FIG. 11 shows a vibration waveform G3 of the first suspension 10A to which the 1 MΩ resistor R1 is connected, and a vibration waveform G4 of the second suspension 10B to which the 1 MΩ resistor R2 is connected, in the second embodiment. A deviation between these vibration waveforms G3 and G4 is larger than the deviation between the vibration waveforms G1 and G2 in the first embodiment (shown in FIG. 8).

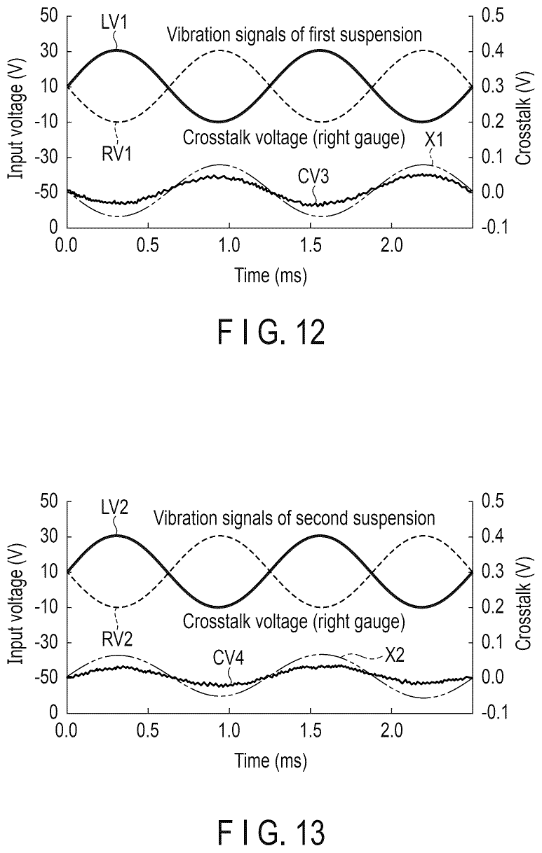

FIG. 12 shows the vibration signal (input voltages RV1 and LV1) supplied to the first suspension 10A (shown in FIG. 5) and a crosstalk voltage CV3, in the second embodiment. A comparatively large crosstalk voltage CV3 is observed in response to the input voltages RV1 and LV1.

This crosstalk voltage CV3 occurs with the same period as the peaks and bottoms of the waveform of the input voltage RV1. As shown in FIG. 5, the conductor 33 of the first suspension 10A is provided along the R-side conductor 41. Furthermore, in the second embodiment, a resistor R1 with a high impedance (for example, 1 MΩ) is connected to the terminal portion 91. As a result, crosstalk corresponding to the waveform of the input voltage RV1 on the R-side conductor 41 occurs at the conductor 33.

FIG. 13 shows the vibration signal (input voltages RV2 and LV2) supplied to the second suspension 10B (shown in FIG. 6) and a crosstalk voltage CV4, in the second embodiment. A comparatively large crosstalk voltage CV4 is observed in response to the input voltages RV2 and LV2.

This crosstalk voltage CV4 occurs with the same period as the peaks and bottoms of the waveform of the input voltage LV2. As shown in FIG. 6, the conductor 73 of the second suspension 10B is provided along the L-side conductor 82. Furthermore, in the second embodiment, a resistor R2 with a high impedance (for example, 1 MΩ) is connected to the terminal portion 95. As a result, crosstalk corresponding to the waveform of the input voltage LV2 on the L-side conductor 82 occurs at the conductor 73.

It is expected that if the impedance of the resistor R1 is higher than 1 MΩ, the crosstalk voltage CV3 shown in FIG. 12 becomes a further larger value as indicated by a two-dot chain line X1. When the terminal portion 91 is in an open state not connected to the ground GND, the resistance value becomes nearly infinite, and there is a possibility that the crosstalk voltage may become further larger. Similarly, it is expected that if the impedance of the resistor R2 is higher than 1 MΩ, the crosstalk voltage CV4 shown in FIG. 13 becomes a further larger value as indicated by a two-dot chain line X2. When the terminal portion 95 is in an open state not connected to the ground GND, the resistance value becomes nearly infinite, and there is a possibility that the crosstalk voltage may become further larger.

Based on the above, the knowledge was obtained that when supplying a vibration signal to the vibration-side piezoelectric element through a conductor, crosstalk can be reduced by connecting the ground GND to the conductor portion which is electrically connected to the non-vibration-side piezoelectric element, via a resistor with a low impedance.

For example, when vibrating the piezoelectric elements 40R and 40L of the first suspension 10A shown in FIG. 5, the ground GND is connected to the terminal portion 91 via a low-impedance resistor R1. For example, if the impedance of each of the piezoelectric elements 40R and 40L is 300 kQ/1 kHz, the impedance of the resistor R1 may be lower than 300Ω. In addition, when vibrating the piezoelectric elements 80R and 80L of the second suspension 10B shown in FIG. 6, the ground GND is connected to the terminal portion 95 via a low-impedance resistor R2. For example, if the impedance of each of the piezoelectric elements 80R and 80L is 300 kQ/1 kHz, the impedance of the resistor R2 may be lower than 300Ω.

### Third Embodiment

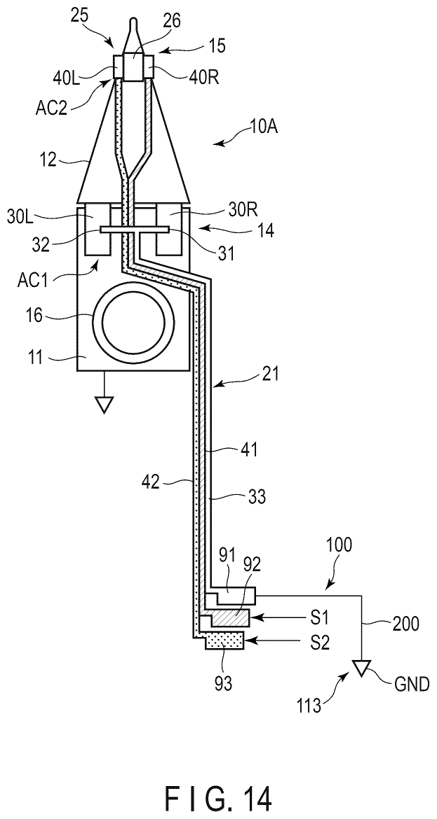

FIG. 14 schematically shows a part of a measurement device 100 of the third embodiment and a first suspension 10A. In this embodiment, a terminal portion 91 electrically connected to piezoelectric elements 30R and 30L on the non-vibration side are connected to a ground GND via a conductor 200. The other constituent elements of the third embodiment are the same as those of the first embodiment. They are denoted by reference numerals common to the embodiments and their descriptions are denoted. A resistance value of the conductor 200 is extremely small but can be considered as a resistance. [0096][Comparative Example 1]

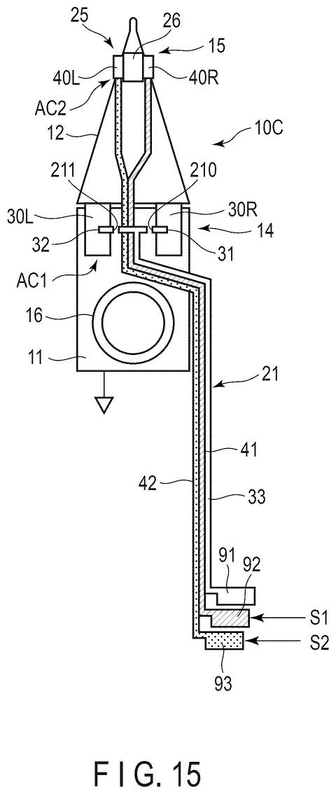

FIG. 15 shows a first suspension 10C of comparative example 1. In a first suspension 10C, a conductor 33 electrically connected to the piezoelectric elements 30R and 30L is cut at cut portions 210 and 211. The terminal portion 91 electrically connected to the conductor 33 is not connected to the ground and is in an open state. The other constituent elements of the first suspension 10C of comparative example 1 are common to those of the first suspension 10A of the first embodiment. Although not shown, a second suspension of comparative example 1 has a mirroring shape with the first suspension 10C.

As shown in FIG. 15, in the first suspension 10C of comparative example 1, the conductor 33 electrically connected to the piezoelectric elements 30R and 30L is cut. However, when vibration signals S1 and S2 are supplied to the vibration-side piezoelectric elements 40R and 40L, crosstalk occurs in the non-vibration-side conductor 33.

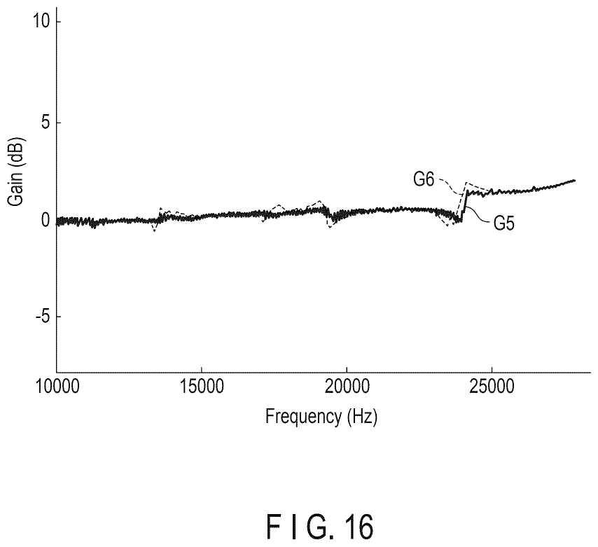

FIG. 16 shows a vibration waveform G5 of the first suspension 10C of comparative example 1 and a vibration waveforms G6 of the second suspension, which has a mirroring shape with the first suspension 10C. The vibration waveforms G5 and G6 are deviated due to the crosstalk.

### Comparative Example 2

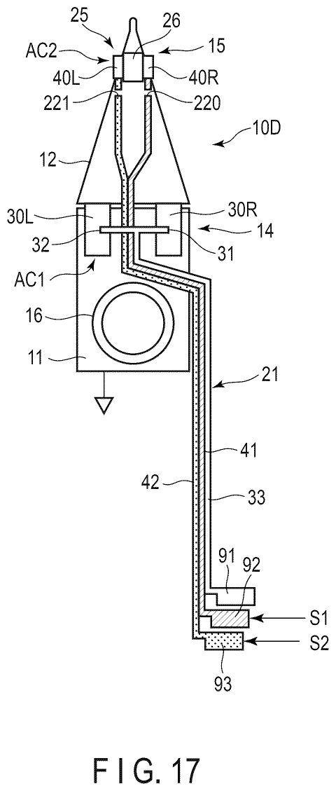

FIG. 17 shows a first suspension 10D of comparative example 2. In a first suspension 10D, conductors 41 and 42 electrically connected to the piezoelectric elements 40R and 40L are cut at cut portions 220 and 221. The terminal portions 91 electrically connected to the conductor 33 is not connected to the ground and is in an open state. The other constituent elements of the first suspension 10D of comparative example 2 are common to those of the first suspension 10A of the first embodiment. Although not shown, a second suspension of comparative example 2 has a mirroring shape with the first suspension 10D.

As shown in FIG. 17, in the first suspension 10D of comparative example 2, the conductors 41 and 42 electrically connected to the piezoelectric elements 40R and 40L on the vibration side are cut. However, when vibration signals S1 and S2 are supplied to these conductors 41 and 42, crosstalk occurs in the conductor 33, causing the non-vibration-side piezoelectric elements 30R and 30L to vibrate slightly.

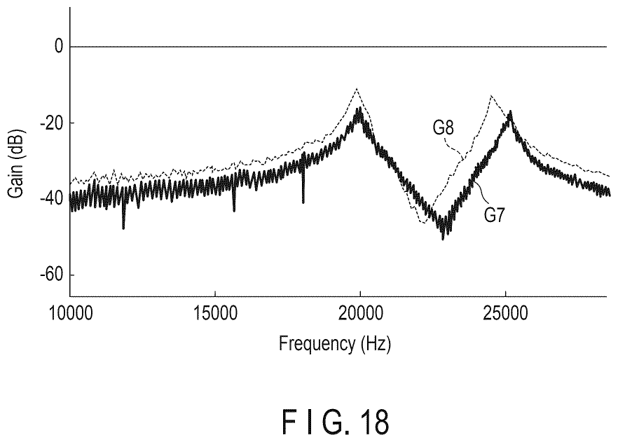

FIG. 18 shows a vibration waveform G7 of the first suspension 10D and a vibration waveforms G8 of the second suspension, which has a mirroring shape with the first suspension 10D. A slight deviation is found in the vibration waveforms G7 and G8 in the vicinity of a gain at an extremely low level of approximately −40 dB.

### Fourth Embodiment

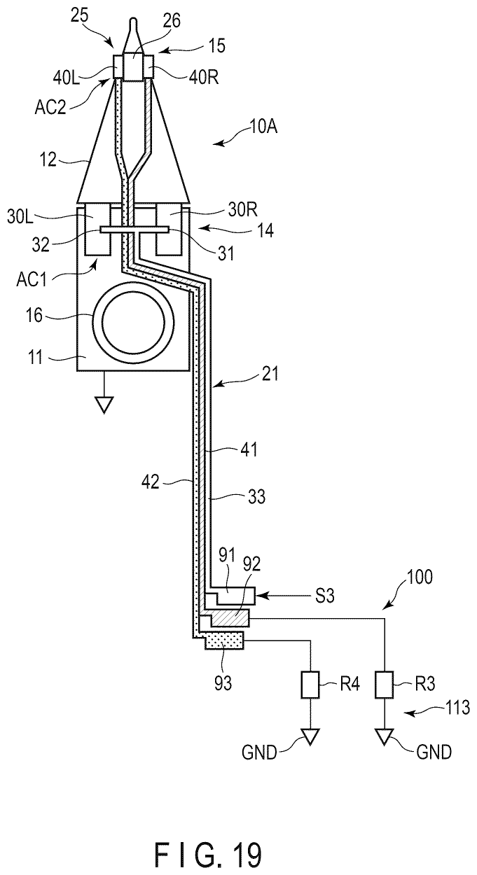

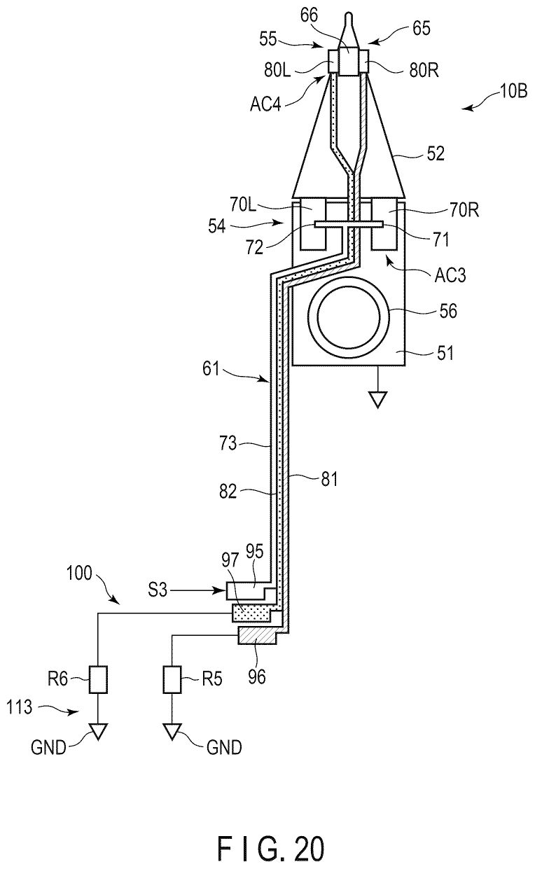

FIG. 19 schematically shows a part of a measurement device 100 according to a fourth embodiment and a first suspension 10A. The first suspension 10A shown in FIG. 19 is common to that of the first embodiment (shown in FIG. 5). FIG. 20 schematically shows a part of the measurement device 100 according to the fourth embodiment and a second suspension 10B. The second suspension 10B shown in FIG. 20 is common to that of the first embodiment (shown in FIG. 6).

As shown in FIG. 19, when measuring the vibration characteristics of the first suspension 10A, a vibration signal S3 is supplied to the piezoelectric elements 30R and 30L at the first position through the conductor 33. Conductors 41 and 42 electrically connected to piezoelectric elements 40R and 40L at the second position are connected to ground GND via resistors R3 and R4, respectively. The impedances of the resistors R3 and R4 may be lower than the impedances of the vibration-side piezoelectric elements 30R and 30L.

As shown in FIG. 20, when measuring the vibration characteristics of the second suspension 10B, a vibration signal S3 is supplied to the piezoelectric elements 70R and 70L at the first position through the conductor 73. Conductors 81 and 82 electrically connected to piezoelectric elements 80R and 80L at the second position are connected to ground GND via resistors R5 and R6, respectively. The impedances of the resistors R5 and R6 may be lower than the impedances of the vibration-side piezoelectric elements 70R and 70L.

It goes without saying that upon carrying out the present invention, the specific aspect of each of the elements constituting the workpiece or the measurement device can be variously modified. In each of the above-described embodiments, an example of the workpiece is the hard disk drive suspension, but the present invention can also be applied to vibration tests of workpieces other than suspensions. The actuator mounted on the workpiece may be any member driven by a vibration signal, and vibration generators other than the piezoelectric elements may also be used.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A measurement device measuring vibration characteristics of a workpiece, the workpiece including:
a first actuator provided at a first position;
a conductor electrically connected to the first actuator;
a second actuator provided at a second position; and
a conductor electrically connected to the second actuator,
the measurement device comprising:
a vibration signal generation unit supplying a vibration signal to one of the first actuator and the second actuator;
a vibration measurement unit detecting vibration generated at the workpiece with the vibration-side actuator to which the vibration signal is supplied, among the first actuator and the second actuator; and
a ground connection unit connecting the non-vibration-side actuator to which the vibration signal is not supplied, among the first actuator and the second actuator, to a ground.

2. The measurement device of claim 1, wherein
the ground connection unit has a resistor, and
the non-vibration-side actuator is connected to the ground via the resistor.

3. The measurement device of claim 2, wherein
the first actuator includes a first piezoelectric element, and
the second actuator includes a second piezoelectric element.

4. The measurement device of claim 3, wherein
an impedance of the resistor is lower than an impedance of the piezoelectric element of the vibration-side actuator.

5. The measurement device of claim 3, wherein
a stroke of the first piezoelectric element is larger than a stroke of the second piezoelectric element,
the first piezoelectric element is connected to the ground connection unit, and
the vibration signal is supplied to the second piezoelectric element.

6. A measurement method of measuring vibration characteristics of a workpiece, the workpiece including:
a first actuator provided at a first position;
a conductor electrically connected to the first actuator;
a second actuator provided at a second position; and
a conductor electrically connected to the second actuator,
the measurement method comprising:
connecting a non-vibration-side actuator to which a vibration signal is not supplied, among the first actuator and the second actuator, to a ground;
supplying a vibration signal to a vibration-side actuator to which the vibration signal is supplied, among the first actuator and the second actuator; and
detecting vibration generated in the workpiece by the vibration-side actuator.

7. The measurement method of claim 6, further comprising:
supplying the vibration signal to the vibration-side actuator in a state in which a resistor is provided between the non-vibration-side actuator and the ground.

8. The measurement method of claim 7, wherein
an impedance of the resistor is lower than an impedance of the vibration-side actuator.
